(19) United States
(12) Patent Application Publication
(10) Pub. No.: US 2015/0359323 A1
(43) Pub. Date: Dec. 17, 2015

(54) SCENT-PRODUCING BRUSH

(71) Applicant: KRL PRODUCTS LLC, Greenwood Village, CO (US)

(72) Inventors: Kristin CLIFT, Lone Tree, CO (US); Vaughan CLIFT, Lone Tree, CO (US); Roxanne MAINE, Greenwood Village, CO (US)

(73) Assignee: KRL PRODUCTS LLC, Greenwood Village, CO (US)

(21) Appl. No.: 14/765,608

(22) PCT Filed: Feb. 5, 2014
(86) PCT No.: PCT/US2014/014907

§ 371 Date: Aug. 4, 2015

Related U.S. Application Data
(60) Provisional application No. 61/761,064, filed on Feb. 5, 2013.

(51) Int. Cl. A46B 11/00; A45D 34/02; A46B 9/02

(52) U.S. Cl. CPC A46B 11/0041; A46B 9/023; A45D 34/02

(57) ABSTRACT

A hairbrush for people and pets is provided that releases perfume, oils, fragrance, or other active compositions when brushed. The hairbrush includes a flexible and selectively deflectable bladder that is deformed when bristles interconnected thereto are moved. Bladder deformation causes air exposed to a scent-producing element positioned within the bladder to be expelled. Removal of external pressures from the bladder causes and ambient air to be captured and scented.

This application claims the benefit of U.S. Provisional Patent Application Ser. No. 61/761,064, filed Feb. 5, 2013, the entire disclosure of which is incorporated by reference herein.

### FIELD OF THE INVENTION

Embodiments of the present invention generally relate to hairbrushes that emit a pleasant scent. The hairbrush of some embodiments of the present invention deposit perfume, fragrance, or other active compositions including, insect repellant, hair conditioning composition, dye composition, moisturizing ingredients, or antibacterial compounds, on an individual's hair or scalp.

### BACKGROUND OF THE INVENTION

Combing or brushing children's hair is often a difficult process, particularly with respect to long, fine hair. It is desirable to make this process pleasurable, which may be achieved by providing a brush that deposits a pleasant scent on the hair or scalp. However, achieving this goal is often difficult.

Brushes possess a handle with interconnected bristles and vary significantly in design. Hairbrush bristles can be rigid, flexible, sharp, or blunted. Further, bristles are mounted on a rigid handle or body structure, which is often made of wood or plastic, or to a flexible member that is interconnected to the body or handle. Selection of a brush suitable to deposit pleasing scent is difficult.

Thus, it is a long felt need to provide a hairbrush that selectively emits or deposits scent-producing material that can also escape hair tangles often encountered when brushing. The following disclosure describes an improved hairbrush having a bladder with scent-producing material that selectively emits a scent or applies the same to an individual's hair or scalp in a pain free and easy manner.

### SUMMARY OF THE INVENTION

It is one aspect of the present invention to provide a hairbrush that deposits scent-producing material when used. One embodiment of the present invention is a hairbrush that has relatively rigid bristles with blunted ends interconnected to a flexible bladder. The contemplated bristles do not scratch the user scalp and are flexible enough to release and slip away from tangled hair, which reduces discomfort.

The hairbrush of one embodiment of the present invention includes a flexible bladder with a small vent port. A scent-producing element is positioned within the bladder. In operation, when the bristles get caught or otherwise impeded by a hair tangle, the bristles deflect and the bladder will compress or otherwise deform, which compresses air within the bladder to release scented air from the vent port. Normal brushing operation may also deform the bladder to release scented air. The expelled air carries the scent produced by the scent-producing element. The vent port is sized to allow scented air to be expelled, but small enough to prevent the free exchange of air from within the bladder to the outside unless the scented air within the bladder is compressed. The vent size also controls passive diffusion of the scented air or essential oils from the bladder.

It is another aspect of the present invention to provide a method of adding pleasant scent or perfume to an individual's hair using only a brush, while leaving no damaging residue, which is counter from hair oils and chemicals commonly used. More specifically, hair perfumes or scented shampoos often leave chemical residue on the individual's hair or scalp. It is desirable to decrease exposure to unnecessary chemicals, toxins, or allergens, which can affect the hair's mechanical properties, such as rigidity, feel, sheen, etc.

It is yet another aspect of embodiments of the present invention to provide a method of manufacturing a scented hairbrush. Commonly, hairbrushes employing a selectively deflectable bladder are manufactured in a one-step molding process. The bladder with interconnected bristles is manufactured separately and later interconnected to a body and handle as they are injection molded. The hairbrushes of some embodiments of the present invention cannot be constructed using these common processes because the scent-producing element could be adversely affected by the heat associated with the injection molding step. Accordingly, some embodiments of the present invention employ an opening or access means that allows a rigid or semi-rigid scent-producing element to be added.

More preferably, however, one embodiment contemplates a method wherein a liquid scent-producing element is added to the bladder by injection through the vent port or through another opening in the wall of the bladder. Because the essential oils or other scent-producing element to be deposited on the individual's hair or scalp are liquid at room temperature, one embodiment of the present invention employs an absorbent pad positioned within the bladder. The pad is incorporated within the bladder before the body and handle is added thereto by way of the injection molding process described above. The pad material absorbs the scent-producing oils and controls scent release to sufficiently saturated air within the bladder.

Another embodiment of the present invention employs a scent-producing element comprising a scented wax having a low temperature melting point. Here, the wax, which is designed to melt above about 125° F. (about 50° C.), is injected directly into the bladder and solidified by cooling. The scent-producing compound, in one embodiment essential oils, dissolves into the wax. The scent-producing compound will evaporate from the surface of the wax and saturate the air within the bladder. In one embodiment of the present invention the essential oil dissolved into the wax lowers the wax's melting point to below about 125° F. (about 50° C.), but still permits the wax to be solid at temperatures below about 95° F. (35° C.).

It is still yet another aspect of the present invention to provide a hairbrush that employs a bladder containing a scent-producing element that can be used for several years. More specifically, the scent-producing element within the bladder rapidly establishes a steady-state with the air inside the bladder, i.e. saturates the air within the bladder. After the saturated air is expelled by movement of the bladder wall, the air captured (i.e., suctioned) by the bladder is also rapidly saturated. With each brushstroke, a quantity of scented oil is dissolved and the scented air is dispelled into the hair.

It is yet another aspect of embodiments of the present invention to provide a hairbrush, comprising: a body portion; a handle potion interconnected to the body portion; a bladder interconnected to the body portion, the bladder portion having a plurality of bristles interconnected to an outer wall thereof, the bladder also having at least one vent; a scent-producing element positioned within an internal volume of the bladder; and wherein the scent-producing element is adapted to saturate air within the volume with scent.

It is another aspect of embodiments of the present invention to provide a method of expelling scent from a hairbrush, comprising: providing a hairbrush comprising a body portion, a handle potion interconnected to the body portion, a bladder interconnected to the body portion, the bladder portion having a plurality of bristles interconnected to an outer wall thereof, the bladder also having at least one vent, and a scent-producing element positioned within an internal volume of the bladder; moving at least one of the plurality of bristles, which deforms a portion of the bladder; changing the internal pressure of the bladder; and expelling air from inside the bladder out the vent, the air being saturated with a scent.

These and other advantages will be apparent from the disclosure of the invention(s) contained herein. The above-described embodiments, objectives, and configurations are neither complete nor exhaustive. As will be appreciated, other embodiments of the invention are possible using, alone or in combination, one or more of the features set forth above or described below. Further, the Summary of the Invention is neither intended nor should it be construed as representing the full extent and scope of the present invention.

Moreover, references made to “the present invention” or aspects thereof should be understood to mean certain embodiments of the present invention and should not be construed as limiting all embodiments to a particular description. The present invention is set forth in various levels of detail in the Summary of the Invention and in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, explain the principles of these inventions.

FIG. 1 is a longitudinal cross section of the hairbrush of one embodiment of the present invention;

FIG. 2 is a transverse cross-section of the hairbrush of one embodiment of the present invention; and

FIG. 3 is a longitudinal cross-section of one embodiment of the present invention showing one mode of operation.

To assist in the understanding of one embodiment of the present invention the following list of components and associated numbering found in the drawings is provided herein:

| # | Component |
|---|---|
| 2 | Scent-producing hairbrush |
| 6 | Hairbrush handle and body |
| 10 | Bladder |
| 14 | Bristle |
| 18 | Internal volume |
| 22 | Scent-producing element |
| 26 | Vent |

It should be understood the drawings are not necessarily to scale. In certain instances, details that are not necessary for an understanding of the invention or that render other details difficult to perceive may have been omitted. It should be understood that the invention is not limited to the particular embodiments illustrated herein.

### DETAILED DESCRIPTION

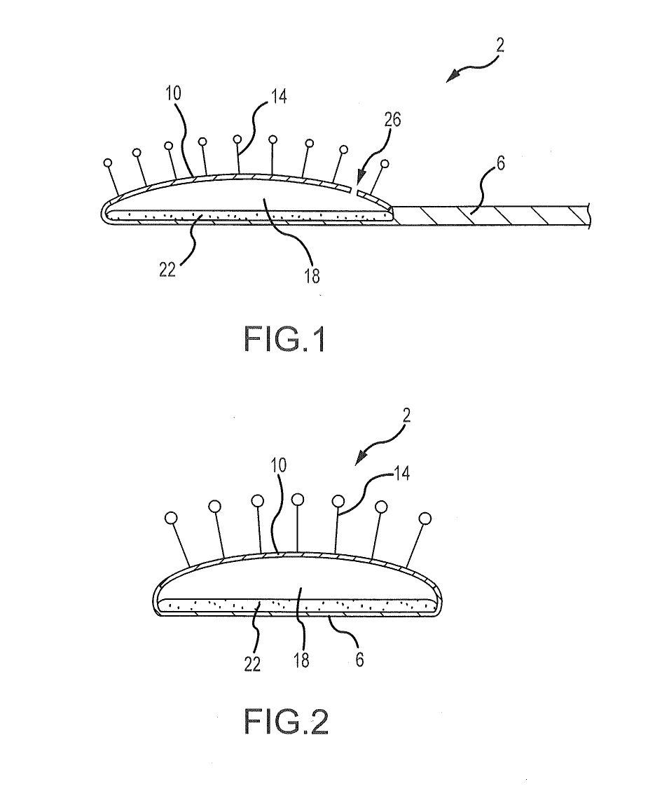

FIGS. 1-3 show a scent-producing hairbrush 2 of one embodiment of the present invention that is generally comprised of a handle/body 6 and interconnected bladder 10. A plurality of bristles 14 are attached to the bladder 10. In one embodiment of the present invention, the bristles 14 have blunt ends.

The bladder 10 is substantially hollow, which defines an internal volume 18 that accommodates a scent-producing element 22. The scent-producing element 22 of one embodiment of the present invention is wax impregnated with scent-producing oils. The bladder 10 also includes at least one vent 26, which preferably allows air and scent to be expelled from the bladder 10 when it is selectively deflected. The vent 26 of one embodiment of the present invention also allows ambient air to enter the internal volume 18 after a mixture of air and scent his expelled from the bladder 10.

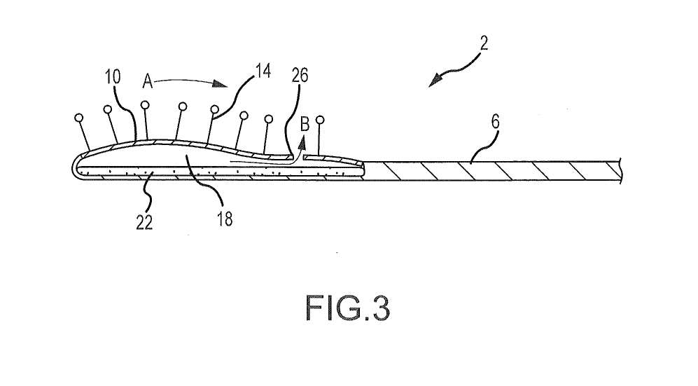

The operation of one embodiment of the present invention is shown and FIG. 3. Here, displacement of the bristles 14 caused by brushing action, which is represented by arrow A, deforms the wall of the bladder 10 to pressurize the internal volume 18. Compression of the internal volume 18 causes air, which is saturated by scent emanating from the center-producing element 22, to exit the vent, as represented by arrow B. After pressure is removed from the bristles 14, the bladder 10 will return to its non-deflected state which draws air through the vent 26 in a direction opposite to the direction associated with arrow B. The new air received within the volume 18 will become saturated with scent emanating from the scent-producing element 22.

The embodiments of the present invention described herein may be constructed using common hairbrush construction methods. Here, however, one embodiment of the present invention employs a wax material inserted within the bladder 10 before the handle and body 6 is interconnected thereto by injection molding. Injection molding process will conceivably melt the wax positioned within the bladder 10, but the vent 26 is sized to prevent substantial escape of the liquid wax from the bladder 10. After the wax 22 is cooled, or while it is still in a semi liquid or liquid state, essential oils or other scent-producing compounds are added to the bladder 10 via the vent 26. The essential oils and wax combine to create the scent-producing element 22 of embodiments the present invention.

Other embodiments the present invention include a scent-producing element 22 formed of a combination of an absorbent material, which is added to the bladder 10 before the handle and body 6 are added thereto. Again, after the structure of the hairbrush 2 is formed, the essential oils are added to the bladder 10 via the vent 26. The absorbent material captures the essential oils to form the scent-producing element 22.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein is capable of other embodiments and of being practiced or of being carried out in various ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

What is claimed is:

1. A hairbrush, comprising:
a body portion;
a handle potion interconnected to said body portion;
a bladder interconnected to said body portion, said bladder portion having a plurality of bristles interconnected to an outer wall thereof, said bladder also having at least one vent;
a scent-producing element positioned within an internal volume of said bladder; and
wherein said scent-producing element is adapted to saturate air within said volume with scent.

2. The hairbrush of claim 1, wherein movement of at least one of said plurality of bristles causes said bladder to compress, thereby pressurizing scented air within said bladder and expelling the same from said vent.

3. The hairbrush of claim 1, wherein said plurality of bristles have blunt ends.

4. The hairbrush of claim 1, wherein said vent is positioned adjacent to said handle.

5. The hairbrush of claim 1, wherein said scent-producing element is an absorbent material that is impregnated with a scent-producing compound.

6. The hairbrush of claim 1, wherein said scent-producing element is a wax that is impregnated with a scent-producing compound.

7. The hairbrush of claim 6, wherein said wax has a melting point of greater than about 50 degrees C.

8. A method of expelling scent from a hairbrush, comprising:
providing a hairbrush comprising a body portion, a handle potion interconnected to said body portion, a bladder interconnected to said body portion, said bladder portion having a plurality of bristles interconnected to an outer wall thereof, said bladder also having at least one vent, and a scent-producing element positioned within an internal volume of said bladder;
deforming a portion of said bladder;
changing the internal pressure of said bladder; and
expelling air from inside the bladder out said vent, said air being saturated with a scent.

9. The method of claim 8, wherein movement of at least one of said plurality of bristles causes said bladder to deform, thereby pressurizing scented air within said bladder and expelling the same from said vent.

10. The method of claim 9, wherein movement of at least one of said plurality of bristles is caused by brushing an individual's hair.

11. The method of claim 8, wherein scented air is expelled from said bladder by pressing on said bladder.

12. The method of claim 8, further comprising impregnating wax with a scent-producing compound to form said scent-producing element.

13. The method of claim 8, further comprising impregnating an absorbent material with a scent-producing compound to form said scent-producing element.

14. The method of claim 8, further comprising:
expanding said bladder;
introducing ambient air into said bladder; and
saturating said introduced air with a scent.
